(19) United States
(12) Patent Application Publication
(10) Pub. No.: US 2024/0296405 A1
(43) Pub. Date: Sep. 5, 2024

(54) SYSTEMS AND METHODS FOR CONTROLLING ACCESS TO COMPUTING SYSTEMS BASED ON DYNAMIC STATE INFORMATION

(71) Applicant: EQUIFAX INC., Atlanta, GA (US)

(72) Inventors: Jennifer Hunter, Atlanta, GA (US); Lisa Lewandowski, Atlanta, GA (US); Amanda Bianco, Staunton, IL (US); Usha Rani Dayalan, Pennington, NJ (US)

(21) Appl. No.: 18/593,377

(22) Filed: Mar. 1, 2024

Related U.S. Application Data
(60) Provisional application No. 63/487,776, filed on Mar. 1, 2023.

(51) Int. Cl. G06Q 10/0635

(52) U.S. Cl. CPC G06Q 10/0635

(57) ABSTRACT

A system can generate a risk report associated with a target entity. For example, the system can receive a request for a risk report associated with a target entity. The system can retrieve a set of records associated with the target entity where each record is associated with a state. The system can generate a first GUI including a selectable list of states associated with each record of the set of records. The system can receive a selection of a first subset of states. The system can transmit, to a remote computing device, the risk report including at least information from a first subset of records associated with the first subset of states for use in controlling access of the target entity to one or more interactive computing environments. The risk report can be used for controlling access of the target entity to one or more interactive computing environments.

### CROSS-REFERENCE TO RELATED APPLICATIONS

This application claims the benefit of U.S. Provisional Application No. 63/487,776, filed Mar. 1, 2023, and titled “TALENT REPORT EMPLOYMENT FLEX-DATA CONFIGURATION,” the entire contents of which is hereby incorporated by reference.

### TECHNICAL FIELD

The present disclosure relates generally to controlling interactions between computing systems. More specifically, but not by way of limitation, this disclosure relates to risk assessment based on past and current state information associated with a target entity for controlling interactions between computing systems.

### BACKGROUND

Various systems use historic data, such as previous current and historic records about the state of an entity or system, to determine an amount of risk associated with that entity or system. To retrieve state records, systems often perform a single query on a large database to retrieve stored state information. This results in inefficiencies for both the information provider and the requestor, who cannot dynamically customize the query or run multiple queries.

### SUMMARY

Various aspects of the present disclosure provide systems and methods for risk assessment using a risk report. The system can receive, via an application programming interface (API) from a remote computing device, a request for a risk report associated with a target entity, where the target entity is associated with an identifier. Responsive to receipt of the request, the system can generate a first trigger event associated with the request and can communicate the first trigger event to an external system. In some aspects, the system can retrieve, from a database, a set of records associated with the target entity based on the identifier. Each record of the set of records can be associated with a state. The system can generate a first graphical user interface (GUI) that is displayed to a user via the remote computing device. The first GUI can include a selectable list of states associated with each record of the set of records. In some aspects, the system can further receive, via the API, a selection of a first subset of the states selected by the user via the first GUI. The system can transmit, to a remote computing device, the risk report including at least information from a first subset of records associated with the first subset of states, wherein the risk report is associated with the trigger event and is useable for controlling access of the target entity to one or more interactive computing environments.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of an operating environment in which a risk assessment computing system can be used to provide a risk assessment associated with a target entity according to some aspects of the present disclosure.

FIG. 2 is a block diagram depicting an example of a risk assessment computing system according to some aspects of the present disclosure.

FIG. 3 is a block diagram depicting a process for generating a risk report associated with a target entity according to some aspects of the present disclosure.

FIG. 4 is a block diagram depicting a process for retrieving a risk report according to some aspects of the present disclosure.

FIG. 5 is a block diagram depicting a process for generating a formatted risk report according to some aspects of the present disclosure.

FIG. 6 is a flow chart illustrating a method for generating a risk report associated with a target entity according to some aspects of the present disclosure.

FIG. 7 is a block diagram depicting an example of a computing device, which can be used to implement the embodiments described herein according to some aspects of the present disclosure.

### DETAILED DESCRIPTION OF THE INVENTION

Disclosed systems and methods relate to risk assessment techniques for controlling access to computing systems based on past and current state data associated with a target entity. For example, an organization may wish to control access to a secure computer system by a target entity based on state information of the target entity. State data can include information about the state of a system (e.g., a connectivity status, CPU usage, amount of available memory) or about the state of an entity or individual. State information for an individual could be, for example, employment data such as current and previous employer names, employer locations, dates of employment, and the like. The state data associated with the target entity can be retrieved by executing a query on a large database storing state information associated with a number of entities, individuals, or systems. A risk assessment computing system can enable an entity to dynamically request state information from a database to generate a risk report that is usable by the entity to control access of the target entity to the secure computer system. An entity may wish to control access of a system to a network, for example, based on previous state data indicative of the systems performance or security vulnerability. In another example, an entity may wish to determine access or eligibility to a position of employment for an individual. Controlling access to computing systems, such as providing access to a secure resource or computing environment, is important to the security of such resources and computing environments. Interactions and access can be controlled based on risk assessments using data detailing a target entity's state history. For example, an entity can compare an employment history provided by the target entity with the employment history included in the risk report to determine a degree of matching between the provided employment history and the retrieved employment history. If the degree of matching is below a predetermined threshold, the target entity can be denied access to the secure computing system. In another example, an entity can compare a system's state data with a predetermined threshold required for the system to access a secure network or secure resource. Access can be denied if the system's historic or current state is below the predetermined threshold.

Disclosed systems and methods can further facilitate auditing and billing of queries to the database storing the state data. The efficiency of retrieving state records can be improved by providing an interface through which a user can dynamically select and retrieve relevant state records. Further, examples of disclosed systems enable auditing and billing of the dynamically generated risk report in a single user session thereby reducing transmission of unnecessary information and reducing repetitive transactions. Additionally, the risk reports and requested information can be audited in real-time to facilitate and confirm regulatory compliance.

By combining the ability to dynamically generate a custom risk report or risk indicator and the ability to bill and audit the custom risk reports, disclosed systems and methods enable an entity to manage control of a target entity's access to a secure system or resource. For example, a user can generate a risk report or risk indicator using the systems and methods described herein and can modify the parameters used to generate the risk report or risk indicator to tailor the risk report or risk indicator to reflect a risk associated with the target entity in terms of user-selected records and data fields. Further, by integrating trigger events to initiate billing and auditing, disclosed systems and methods can interact with internal or external components to invoice and track each generated risk report or risk indicator. For example, multiple trigger events can be associated with a single session, such that a single bill can be generated for the session, thereby reducing transmissions between systems and transactions between the requesting system and the system generating the risk report or risk indicator. Further, tracking each requested report and recording the report data and report metadata (e.g., a requestor identifier, an organization originating the request, a request date, and the like) can facilitate internal and external auditing of the risk reports, and can enable previously generated reports to be easily retrieved and modified. Accordingly, disclosed systems and methods provide a dynamic and efficient platform through which to control access of a target entity to a secure system or resource.

Certain aspects described herein for performing risk assessments on target entities using past and current state data associated with the target entities can improve existing systems by seamlessly and dynamically retrieving state data. In some examples, the risk report can include a risk indicator, for example, that indicates a degree of matching between the retrieved state information and state information provided by the target entity, or that indicates the result of comparing the state information with a predetermined threshold. Generating a risk indicator (e.g., a score indicating a degree of risk associated with allowing a target entity to access a computing environment) associated with the target entity based on the degree of matching can improve the efficiency of, for example, background or employment check operations. Disclosed systems and methods can deliver an immediate risk indicator, or indication that the retrieved state information does not match the state information provided by the target entity, to enable the requesting system to take immediate action in granting access of the target entity to a restricted system or resource. In some examples, the risk indicator can be a numerical or binary indicator of a level of risk associated with the target entity (e.g., the risk indicator can indicate a higher level of risk if it appears the target entity provided erroneous or fabricated state information). In other examples, disclosed systems can provide a risk report including the retrieved state data to the requesting system. The requesting system can then perform independent analysis on the report to determine whether to grant access to the target entity.

In some examples, a risk assessment computing system can receive a request for a risk report associated with a target entity. If the target entity is an individual, the request can include an identifier, such as an SSN or other combination of personally identifiable information (PII), associated with the target entity. In another example, the identifier can be a serial number of a system or an IP address. The risk assessment computing system can query a database based on the identifier to retrieve a set of records associated with the target entity. The set of records can include a record for each state associated with the target entity. For a system, each state can be associated with a different period of time (e.g., each state can correspond to a day, hour, week, etc.). For an individual, each state can correspond with a period of employment with a particular employer, a time period in which the individual resided at a particular address, etc. For example, each record can include an employer name, employer location, position held, dates of employment, and the like. For an organization or other entity, the state can be, for example, the organization's state for a particular quarter or fiscal year.

The risk assessment computing system can generate a first graphical user interface (GUI) to be displayed to a user via a remote computing device of the user. The first GUI can display a selectable list of states associated with the set of records. Thus, rather than expending computing resources to retrieve, format, and transmit the information contained in the entire set of records, disclosed systems can provide state information associated with only those states selected via the first GUI. Once the user selects a subset of states, the risk assessment computing system can generate a risk report including information associated with the subset of states. In some examples, the first GUI can display a selectable list of fields of data to include in the risk report or a delivery method for the risk report (e.g., display via GUI, a pdf download, a csv file download, etc.).

In some aspects, the risk assessment computing system can generate a risk report including the retrieved state information from the records associated with the subset of states. The risk report can be generated to include data associated with the fields selected by the user via the first GUI. The risk report can also be generated in the selected delivery format. For example, if the user selected to receive the report in a GUI, the risk assessment computing system can generate executable code configured to cause a remote computing device to display a GUI including the retrieved information associated with the subset of states.

In some aspects, the risk assessment computing system can display a second GUI including the retrieved information associated with the selected subset of states as well as a second selectable list of states. The user can select a second subset of states thereby causing the risk assessment computing system to generate an updated risk report including the state information contained in records associated with the states in the second subset of states. To facilitate billing and auditing, each time a risk report is generated, the risk assessment computing system can generate a trigger event. An indication of the trigger event can be transmitted or otherwise communicated to external billing and auditing systems. For example, a trigger event can cause and external billing system or internal billing service to generate an invoice for the retrieved records associated with the states selected by the user. Additionally, the auditing system or auditing service can, in response to the trigger event, generate an audit of the risk report including identification of the user, the target entity, and the retrieved information.

In some aspects, the risk assessment computing system can generate a risk indicator that is included in the risk report transmitted to the remote computing device. The risk indicator can reflect a level of risk associated with the target entity. For example, if the target entity is an individual, the risk indicator can be a degree of matching between employment information provided by the target entity and employment information retrieved from the database such that a lower degree of matching correlates to a higher level of risk. In another example, for a system, the state information can be compared with a predetermined threshold. The risk indicator, and the information included in the risk report, can be used by the requesting entity to control access of the target entity to a secure computing environment. For example, the risk indicator can be included in a responsive message to the request for evaluating the target entity such that the responsive message can be used to allow, challenge, or deny access to the target entity. For example, if the risk indicator is below a predefined threshold, a request by the target entity to access the interactive computing environment may be automatically denied or flagged for manual review.

Certain aspects described herein, which can include retrieving and analyzing state information associated with target entities and providing a responsive message indicating a risk associated with the target entities based on analysis of the retrieved state information, can improve at least the technical fields of controlling interactions between computing environments, access control for a computing environment, or a combination thereof. For instance, by generating and transmitting the responsive message, the risk assessment computing system can cause access to a computing system to be controlled more accurately. The risk assessment computing system can use a number of methods to access and query discrete databases to retrieve state data associated with a target entity. The retrieved state data can be verified, compiled, and analyzed to generate a report and a risk indicator. The state data can be analyzed to determine a level of risk of the target entity based on a comparison of the state data with a predetermined threshold or with state data provided by the target entity itself. The responsive message can include the retrieved state data, such as state data records retrieved from a database. The responsive message can facilitate a practical application of the state data retrieval and analysis techniques described herein by facilitating control of a real-world process such as a background check. Additionally or alternatively, by using the techniques described herein, a risk assessment computing system may provide legitimate access to the interactive computing environment more efficiently and using fewer computing resources compared to other risk assessment systems or techniques. For example, the risk assessment computing system can determine a risk indicator or an actionable response message efficiently thereby reducing the (i) memory usage, (ii) processing time, (iii) network bandwidth usage, (iv) response time, and the like for controlling access to the interactive computing. Accordingly, the risk assessment computing system improves the access control for computing environment by reducing memory usage, processing time, network bandwidth consumption, response time, and the like with respect to controlling access to the interactive computing environment using at least the system architecture and techniques described herein

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

Operating Environment Example for Generating a Risk Indicator Associated with a Target Entity

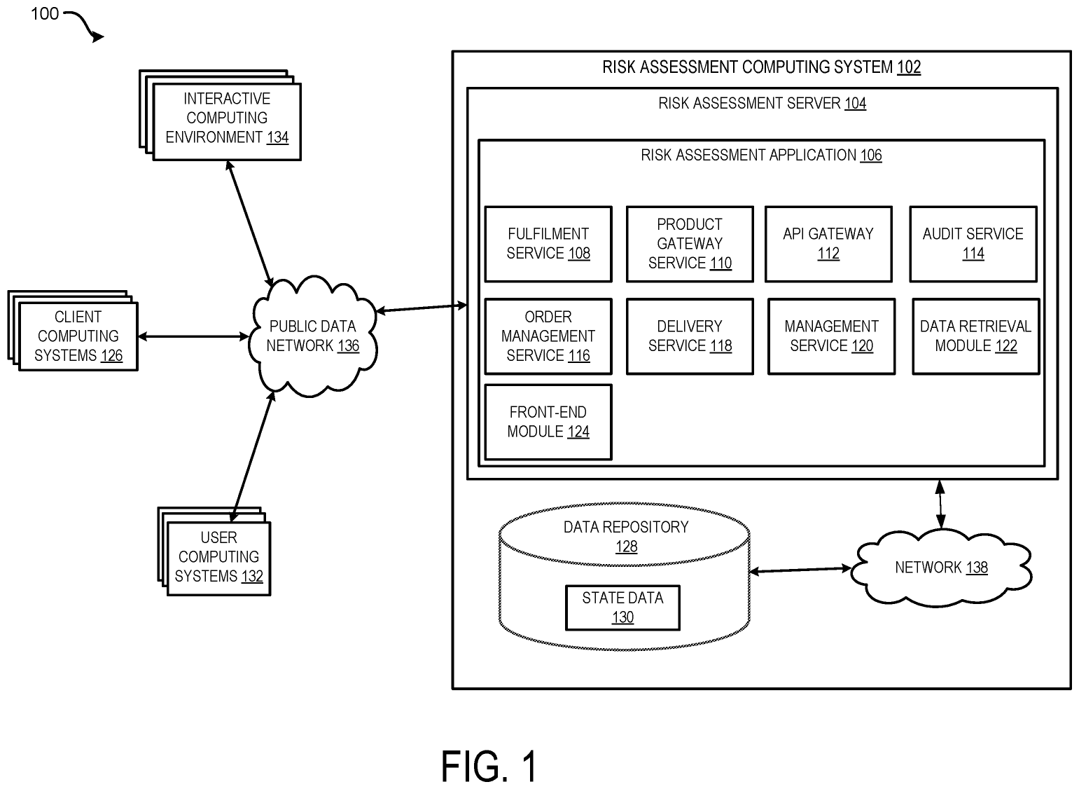

Referring now to the drawings, FIG. 1 is a block diagram depicting an example of an operating environment in which a risk assessment computing system can be used to provide a risk assessment associated with a target entity according to some aspects of the present disclosure. FIG. 1 depicts examples of hardware components of a risk assessment computing system 102, according to some aspects. The risk assessment computing system 102 can be a specialized computing system that may be used for processing large amounts of data using a large number of computer processing cycles. In other examples, the risk assessment computing system 102 may be or include a general-purpose computing system. The risk assessment computing system 102 can include a risk assessment server 104 for performing a risk assessment (e.g., predicting future risk associated with the target entity, predicting the legitimacy of the target entity, etc.) with respect to a target entity, such as a target individual or a user computing device. The risk assessment can be based on state information associated with the target entity and can be used by a client computing system 124 to evaluate a risk associated with a target entity.

The risk assessment server 104 can include one or more processing devices that can execute program code, such as a risk assessment application 106. The program code can be stored on a non-transitory computer-readable medium or other suitable medium. The risk assessment application 106 can include one or more modules or components executing software code to complete one or more steps for determining a risk indicator. For example, the risk assessment application 106 can include: a fulfilment service 108; a product gateway service 110; an API gateway 112; an audit service 114; an order management service 116; a delivery service 118; a management service 120; a data retrieval module 122; and a front-end module 124. The front-end module 124 can generate executable code for providing a GUI to a user (e.g., via a user computing system 132 or a client computing system 126). The user can interact with the risk assessment application 106 through the API gateway 112 by interacting with the GUI provided by the front-end module 124. The fulfilment service 108 can receive, for example, a request from a client computing system 132 for a risk report associated with a target entity. The fulfilment service 108 can receive the request via the API gateway 112 and call one or more services or modules to handle the request. For example, the fulfilment service 108 can generate a trigger event causing the order management service 116 to log the request and generate a billing session associated with the request. The trigger event can also cause the audit service 114 to generate and store a log of the requestor, information in the request, and a date/time of the request. In some examples, a user can request the risk report to be generated in a particular format. The fulfilment service 108 can communicate retrieved risk report information and an indication of the desired delivery method to the delivery service 118 for conversion into the desired format. The fulfilment service 108 can also interact with a management service 120 to authenticate the user submitting the request and to retrieve a configuration associated with the user (e.g., a set of permissions indicating what services or information the user has access to). To fulfil the request for the risk report, the fulfilment service 108 can interact with the product gateway service 110 by providing request instructions. The product gateway service 110 can pass the instructions to the data retrieval module 122, which can generate a query and query a data repository 128, containing state data. The state data can be communicated back to the fulfilment service 108 and used by the delivery service 118 to generate a formatted report to be delivered to the requesting user.

The risk assessment server 104 can perform risk assessment operations or access control operations for validating or otherwise authenticating the target entity, for example using other suitable modules, models, components, etc. of the risk assessment server 104. The risk assessment server 104 can receive data (e.g., state data) associated with the target entity from the data repository 128, or any suitable combination thereof. In some aspects, the risk assessment application 106 can authenticate or deny a request for an interaction involving the target entity by generating a risk indicator using the target entity state data retrieved from the data repository 128.

In some aspects, the target entity data can be determined or stored in one or more network-attached storage units on which various repositories, databases, or other structures are stored. An example of these data structures can include the data repository 128. In some examples, the state data 130 can be associated with a number of entities and can be searchable using identifying information associated with each entity. For example, records storing state data 130 can be searched using an SSN associated with an individual, or a serial number associated with a system component.

Network-attached storage units may store a variety of different types of data organized in a variety of different ways and from a variety of different sources. For example, the network-attached storage unit may include storage other than primary storage located within the risk assessment server 104 that is directly accessible by processors located therein. In some aspects, the network-attached storage unit may include secondary, tertiary, or auxiliary storage, such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the risk assessment computing system 102 can communicate with various other computing systems. The other computing systems can include user computing systems 132, such as smartphones, personal computers, etc., client computing systems 126, and other suitable computing systems. For example, user computing systems 132 may transmit, such as in response to receiving input from the target entity, requests for accessing the interactive computing environment 134 to the client computing systems 126. In response, the client computing systems 126 can send authentication queries (e.g., a request for a risk indicator or risk report) to the risk assessment server 104, and the risk assessment server 104 can receive data associated with the target entity used in the request and generate a risk indicator or risk report associated with the target entity. While FIG. 1 illustrates that the risk assessment computing system 102 and the client computing systems 126 are separate systems, the risk assessment computing system 102 and the client computing systems 126 can be one system. For example, the risk assessment computing system 102 can be a part of the client computing systems 126, or vice versa.

As illustrated in FIG. 1, the risk assessment computing system 102 may interact with the client computing systems 126, the user computing systems 132, or a combination thereof via one or more public data networks 136 to facilitate interactions between users of the user computing systems 122 and the interactive computing environment 134. For example, the risk assessment computing system 102 can facilitate the client computing systems 126 providing a user interface to the user computing system 132 for receiving various data from the user, for example, user-provided state data. The risk assessment computing system 102 can transmit validated risk assessment data, for example similarity-preserving hashes, comparisons or scores determined therefrom, etc., to the client computing systems 126 for providing, challenging, or rejecting, etc. access of the target entity to the interactive computing environment 134. In some examples, the risk assessment computing system 102 can additionally communicate with third-party systems to receive risk assessment data, entity data, state data, and the like, through the public data network 136. In some examples, the third-party systems can provide real-time (e.g., streamed) data about the target entity, historical data about the target entity, etc. to the risk assessment computing system 102.

Each client computing system 126 may include one or more devices such as individual servers or groups of servers operating in a distributed manner. A client computing system 126 can include any computing device or group of computing devices operated by a seller, lender, or other suitable entity that can provide products or services. The client computing system 126 can include one or more server devices. The one or more server devices can include or can otherwise access one or more non-transitory computer-readable media.

The client computing system 126 can further include one or more processing devices that can be capable of providing an interactive computing environment 134, such as a user interface, etc., that can perform various operations. The interactive computing environment 134 can include executable instructions stored in one or more non-transitory computer-readable media. The instructions providing the interactive computing environment 134 can configure one or more processing devices to perform the various operations. In some aspects, the executable instructions for the interactive computing environment 134 can include instructions that provide one or more graphical interfaces. The graphical interfaces can be used by a user computing system 132 to access various functions of the interactive computing environment 34. For instance, the interactive computing environment 134 may transmit data to and receive data, such as via the graphical interface, from a user computing system 132 to shift between different states of the interactive computing environment 134, where the different states allow one or more electronic interactions between the user computing system 132 and the client computing system 126 to be performed.

In some examples, the client computing system 126 may include other computing resources associated therewith (e.g., not shown in FIG. 1), such as server computers hosting and managing virtual machine instances for providing cloud computing services, server computers hosting and managing online storage resources for users, server computers for providing database services, and others. The interaction between the user computing system 132, the client computing system 126, and the risk assessment computing system 102, or any suitable sub-combination thereof may be performed through graphical user interfaces, such as the user interface, presented by the risk assessment computing system 102, the client computing system 126, other suitable computing systems of the computing environment 100, or any suitable combination thereof. The graphical user interfaces can be presented to the user computing system 132. Application programming interface (API) calls, web service calls, or other suitable techniques can be used to facilitate interaction between any suitable combination or sub-combination of the client computing system 126, the user computing system 132, and the risk assessment computing system 102.

A user computing system 132 can include any computing device or other communication device that can be operated by a user or entity, such as the user entity, which may include a consumer or a customer. The user computing system 132 can include one or more computing devices such as laptops, smartphones, and other personal computing devices. A user computing system 132 can include executable instructions stored in one or more non-transitory computer-readable media. The user computing system 132 can additionally include one or more processing devices configured to execute program code to perform various operations. In various examples, the user computing system 132 can allow a user to access certain online services or other suitable products, services, or computing resources from a target entity, such as the client computing system 126, to engage in mobile commerce with the client computing system 126, to obtain controlled access to electronic content, such as the interactive computing environment 134, hosted by the client computing system 126, etc.

In some examples, the user or a target entity can use the user computing system 132 to engage in an electronic interaction with the client computing system 126 via the interactive computing environment 134. The risk assessment computing system 102 can receive a request, for example from the user computing system 132, to access the interactive computing environment 134 and can use target entity data or any other suitable data or signals determined therefrom, to determine whether to provide access, to challenge the request, to deny the request, etc. An electronic interaction between the user computing system 132 and the client computing system 126 can include, for example, the user computing system 132 being used to request a financial loan or other suitable services or products from the client computing system 126, and so on. An electronic interaction between the user computing system 132 and the client computing system 126 can also include, for example, one or more queries for a set of sensitive or otherwise controlled data, accessing online financial services provided via the interactive computing environment 134, submitting an online credit card application or other digital application to the client computing system 126 via the interactive computing environment 134, operating an electronic tool within the interactive computing environment 134 (e.g., a content-modification feature, an application-processing feature, etc.), etc. In another example, a user of the user computing system 132 can request a risk report associated with a target entity. The client computing system 126 can receive the request and interact with the risk assessment computing system 102 to fulfil the request for a risk indicator or risk report associated with the target entity.

In some aspects, an interactive computing environment 134 implemented through the client computing system 126 can be used to provide access to various online functions. As a simplified example, a user interface or other interactive computing environment 134 provided by the client computing system 126 can include electronic functions for requesting computing resources, online storage resources, network resources, database resources, or other types of resources. In another example, a website or other interactive computing environment 134 provided by the client computing system 126 can include electronic functions for obtaining one or more financial services, such as an asset report, management tools, credit card application and transaction management workflows, electronic fund transfers, etc.

A user computing system 132 can be used to request access to the interactive computing environment 134 provided by the client computing system 126. The client computing system 126 can submit a request, such as in response to a request made by the user computing system 132 to access the interactive computing environment 134, for risk assessment to the risk assessment computing system 102 and can selectively grant or deny access to various electronic functions based on risk assessment performed by the risk assessment computing system 102. Based on the request, or continuously or substantially contemporaneously, the risk assessment computing system 102 can determine one or more risk signals or risk indicators for data associated with the target entity, which may submit or may have submitted the request via the user computing system 132. The risk indicator can be based on current and historic state data retrieved from the data repository 128. Based on a risk indicator or the information in the risk report, the risk assessment computing system 102, the client computing system 126, or a combination thereof can determine whether to grant the access request of the user computing system 132 on behalf of the target entity to certain features of the interactive computing environment 134. The risk assessment computing system 102, the client computing system 126, the user computing system 132 or a combination thereof can use the risk indicator for other suitable purposes such as identifying a manipulated identity, controlling a real-world interaction, and the like.

In a simplified example, the system illustrated in FIG. 1 can configure the risk assessment server 104 to be used for controlling access to the interactive computing environment 134. The risk assessment server 104 can retrieve data associated with the target entity in response to a request to access the interactive computing environment 134. The data may, for example, be retrieved based on identity information (e.g., information collected by the client computing system 126 via a user interface provided to the user computing system 132, or information associated with a target entity that is provided by the user of the user computing system 132) provided by the client computing system 126 or received via other suitable computing systems. The risk assessment server 104 can retrieve the data associated with the target entity from the data repository 128. The data repository 128 can store, for example, state data associated with one or more past or current states the target entity. As discussed above, a state can be, for example, an operational state of a system or a period of an individual's employment with an employer. The risk assessment server 104 can determine a risk indicator or risk report associated with the target entity based on an analysis (e.g., using NLP or other machine-learning techniques) of the state data. The risk assessment server 104 can transmit the risk indicator, risk report, or any inference derived therefrom, to the client computing system 126 or the user computing system 132 for use in controlling access to the interactive computing environment 134.

The risk indicator associated with the target entity, or any suitable score or comparison determined therefrom, can be used, for example by the risk assessment computing system 102, the client computing system 126, user computing system 132, etc., to determine whether the risk associated with the target entity accessing a good or a service provided by the client computing system 126 or the user computing system 132 exceeds a threshold, thereby granting, challenging, or denying access by the target entity to the interactive computing environment 134. For example, if the risk assessment computing system 102 determines that the risk indicator indicates that risk associated with the target entity is lower than a threshold value or that it deviates from target entity-provided state information, then the client computing system 126 associated with the service provider can generate or otherwise provide access permission to the user computing system 132 that requested the access. The access permission can include, for example, cryptographic keys used to generate valid access credentials or decryption keys used to decrypt access credentials. The client computing system 126 can also allocate resources to the target entity and provide a dedicated web address for the allocated resources to the user computing system 132 or to the target entity, for example, by adding the user computing system 132 in the access permission. With the obtained access credentials or the dedicated web address, the user computing system 132 can establish a secure network connection to the interactive computing environment 134 hosted by the client computing system 126 and access the resources via invoking API calls, web service calls, HTTP requests, other suitable mechanisms or techniques, etc.

In some examples, the risk assessment computing system 102 may determine whether to grant, challenge, or deny the access request made by the user computing system 132 for accessing the interactive computing environment 134. For example, based on the risk indicator associated with the target entity, the risk assessment computing system 102 can determine that the target entity is a legitimate entity that made the access request and may authenticate the request. In another example, the risk indicator can reflect a risk associated with the target entity based on whether target entity-provided state information matches the state information retrieved from the data repository 128. In other examples, the risk assessment computing system 102 can challenge or deny the access attempt if the risk assessment computing system 102 determines that the target entity may not be a legitimate entity.

In some examples, the risk indicator used to determine access to the interactive computing environment 134 may be determined at least in part based on analysis of the state data retrieved from the data repository 128. For example, the state data retrieved from the data repository 128 can be compared with one or more predetermined thresholds. In another example, the risk indicator can reflect a degree of matching between the retrieved state data and a reference dataset or between the retrieved state data and target entity-provided state data.

Each communication within the computing environment 100 may occur over one or more data networks, such as a public data network 136, a network 138 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices illustrated in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate may be instead implemented in a signal device or system.

System for Generating a Risk Indicator Associated with a Target Entity

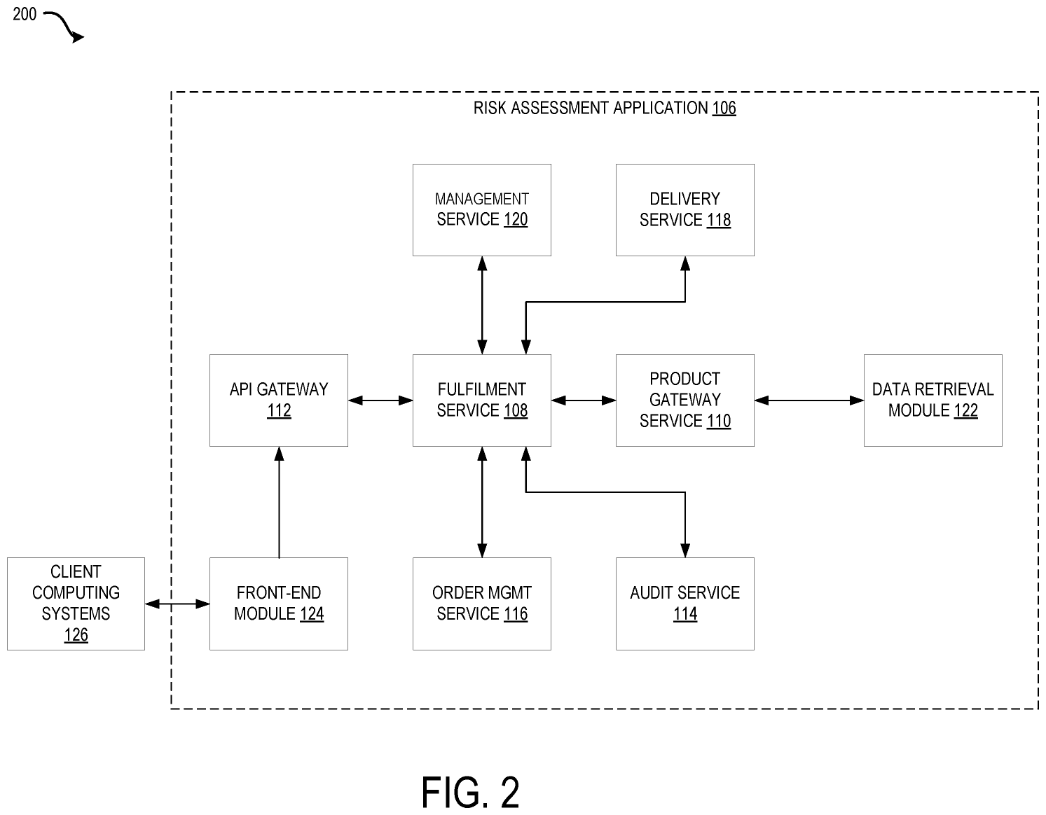

FIG. 2 is a block diagram depicting an example system 200 for generating a risk assessment associated with a target entity according to some aspects of the present disclosure. The system 200 can be implemented by any of the components as described above with reference to FIG. 1. For example, the system 200 described with respect to FIG. 2 can be executed by the risk assessment server 102 via one or both of public network 136 and network 138, or using any other components or systems described with reference to FIG. 1. Other implementations or architectures, however, are possible.

The client computing system 126 can receive an access request from the user computing system 132, where the request is associated with a target entity. In turn, the client computing system 126 can generate a request and communicate that request to the risk assessment application 106 through an interface displayed on the client computing system 126. The interface can be generated as a result of executing the front-end module 124.

The risk assessment application 106 can receive the request, including the target entity identifier, that have been input via the front-end module 124 through the API gateway 112. The risk assessment application 106 can receive the request at the fulfilment service 108. In some examples, the request can include the target entity identifier and an identifier associated with the user of the client computing system 126. For example, the request can include log in credentials, a username, or other unique identifier of the user of the client computing system 126. The fulfilment service 108 can communicate the identifier to the management service 120 for authentication.

The management service 120 can authenticate the user of the client computing system 126 using the authentication information (e.g., a username and password) or using any other method of authentication or multi-factor authentication. Additionally, the management service 120, or the fulfilment service 108, can access a user database storing account configurations. An account configuration can define the permissions of the user or of the organization to which the user belongs. For example, permissions can define subsets of state data which the user is restricted from accessing. Permissions can also define which data fields the user can access, or which report types the user can access. In some examples, permissions can include location-based restrictions on what data can be retrieved from the data repository 128 or requirements (e.g., additional information or certifications) to access certain data.

Once the user is authenticated by the management service 120, the fulfilment service 108 can generate a trigger event. The trigger event can be used by the order management service 116 to initiate a report order and billing session, and by the audit service 114 to initiate an audit record associated with the request. For example, the order management service 116 can interact with one or more internal or external systems to bill the user based on the custom generated report. Billing can be based on, for example, predefined billing codes associated with the type of report, information included in the report, number of target entities for which reports are generated, or method of delivery of the report. The auditing service 114 can record interactions between the user and the risk assessment application 106 for compliance or auditing purposes. For example, the auditing service 116 can record an identifier of the user or organization requesting the report, the target entity for which the report was generated, the date or time of the request, the types of information requested by the user, and the like.

The fulfilment service 108 can pass the target entity identifier to the product gateway service 110, which in turn passes the target entity identifier to the data retrieval module 122. The data retrieval module 122 can be an intermediary layer acting as an interface between the risk assessment application 106 and the data repository 128. The data retrieval module 122 can generate a query based on the target entity identifier where the query is configured to return any records from the data repository 128 that are associated with the target entity. By executing the query, the data retrieval module 122 can receive a set of records from the data repository that are associated with the target entity, where each record is associated with a particular state of the target entity. For example, in the case of an individual, each record can be associated with a period of employment with a particular employer.

The data retrieval module 122 can compile a list of states associated with the set of records and pass the list of states, via the product gateway service 110, to the fulfilment service 108. The fulfilment service 108 can cause the front-end module 124 to generate a GUI displaying a selectable list of states. The user of the client computing system 126 can interact with the risk assessment application 106 via the GUI to select one or more states from which to generate the requested risk report. In some aspects, the GUI may also display, based on the permissions of the user, a selectable list of one or more data fields that the user has permission to access. Accordingly, using the GUI, the user can request to generate a report based on, for example, a subset of states that includes a subset of data fields. In some aspects, the GUI can also include a selectable list of delivery options for the risk report. The delivery options can include various delivery methods or formats such as PDF download, plaintext download, and the like.

The fulfilment service 108 can receive the selections input by the user and initiate actions by one or more of the components of the risk assessment application 106. For example, the fulfilment service 108 can communicate the number of states (e.g., number of records) and, in some examples, the number of data fields selected to the order management service 116 and the audit service 114. The order management service 116 can associate a billing code with the requested risk report based on the selections made by the user. Similarly, the audit service 114 can generate an audit record including the selections made by the user.

The fulfilment service 108 can communicate with the product gateway service 110 to retrieve the state data contained in the query results previously obtained by the data retrieval module 122. The retrieved state data can include, for example, dates that the target entity was in the state, a definition of the state, a state identifier, one or more characteristics of the state, and the like. For example, if the state corresponds to a period of employment, the data contained in the record can include dates of employment, an employer identifier, a job type, one or more job responsibilities, a location, etc.

The retrieved state data can be communicated by the fulfilment service 108 to the delivery service 118. The delivery service 118 can also receive an indication of the delivery method selection from the user. In some aspects, the delivery service 118 can format the data as a PDF document or other document format available for download by the user via the API gateway 112. In another example, the delivery service 118 can generate executable code to cause the front-end module 124 to display a GUI containing the retrieved state information.

Process for Generating a Risk Indicator Associated with a Target Entity

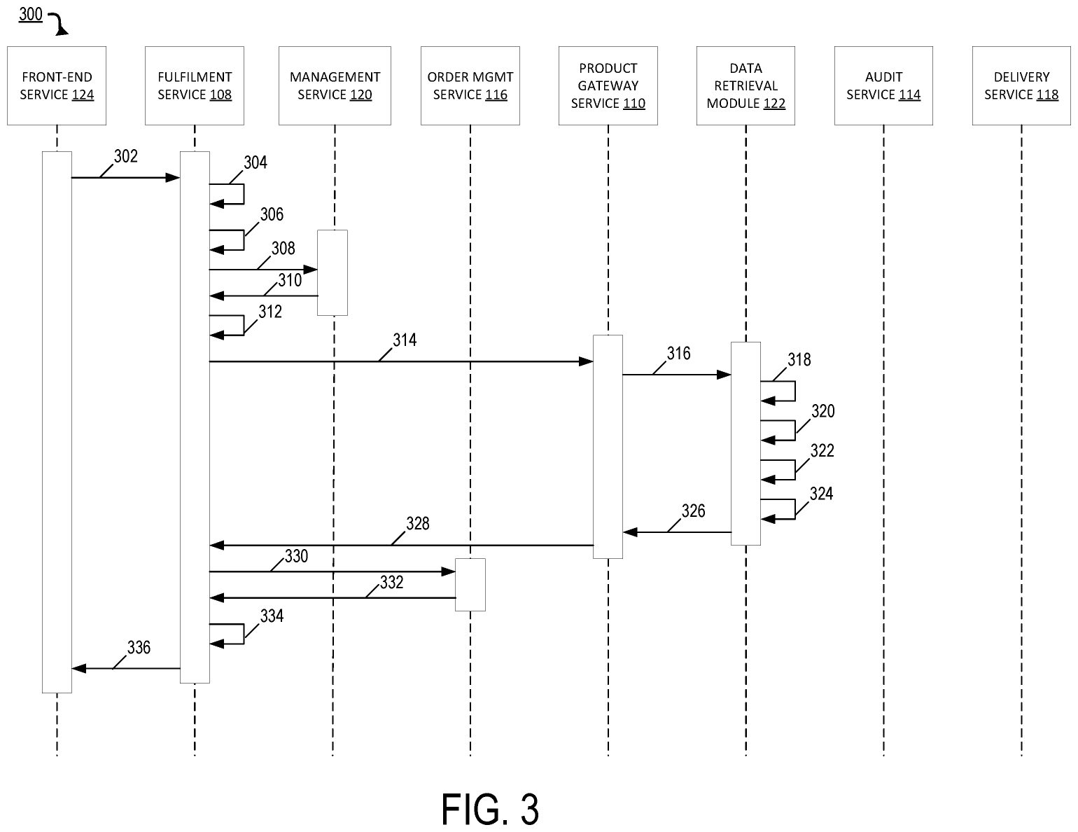

FIG. 3 is a block diagram depicting an example process 300 for generating a risk assessment associated with a target entity according to some aspects of the present disclosure. The process 300 can be implemented by any of the components as described above with reference to FIG. 1 or FIG. 2. For example, the interactions described with respect to FIG. 3 can be executed by the risk assessment server 102 via one or both of public network 136 and network 138. Other implementations or architectures, however, are possible.

At interaction 302, the process 300 can include transmitting a request for a risk report to the fulfilment service 108. The risk report request can be received via the front-end module 124 as input provided by a user of the client computing system 126. The request can include information such as a target entity identifier, a user identifier or user login credentials, and a token. The fulfilment service 108 can, at interaction 304, validate the received request, for example, to determine whether the request includes a valid target entity identifier (e.g., a valid serial number or valid SSN) and a valid user identifier. At interaction 306, the process 300 can include validating the token provided by the client computing device 126 as part of the request. In some aspects, the token can be, for example, a JSON web token (JWT) and can be used to verify the user or the client computing system 126.

At interaction 308, the process 300 can include retrieving, from the management service 120, the configuration associated with the user of the client computing system 126. The configuration can be, for example, a file or record stored in a configuration database that defines the permissions of the user or of an organization to which the user belongs. The management service 120 can, for example, query the configuration database based on the user identifier or an identifier associated with the organization to which the user belongs. The configuration file or record can be transmitted, at interaction 310, to the fulfilment service 108.

At interaction 312, the process 300 can include determining, based on the configuration record or file, the permissions of the user. For example, the fulfilment service 108 can parse the configuration record or file, determine the permissions associated with the user, and generate instructions on what state information can be requested from the data repository 128 by the user. As an example, based on the information included in the received request and the user permissions, the fulfilment service 108 can determine that the user can access a particular subset of state data associated with the target entity.

At interaction 314, the process 300 can include transmitting a request for state data associated with the target entity from the product gateway service 110. This request is then transmitted to the data retrieval module 122 at interaction 316. The data retrieval module 122 can generate a query based on the target entity identifier and any permissions or restrictions associated with the user.

At interaction 318, the process 300 can include executing, by the data retrieval module 122, the generated query on the data repository 128. Further, at interaction 320, the process 300 can include generating, by the data retrieval module 122, a risk report including the retrieved data. In some examples, the data retrieval module 122 can also generate a risk indicator by comparing the retrieved state data with a threshold, reference data, or target entity-provided data. In some examples, generated risk report can be created, at least in part, based on the permissions associated with the user. For example, the risk report can include only that state data to which the user has permission to access.

In some aspects, to avoid falsely attributing a record to the target entity, the risk assessment application 106 can determine confirm that an entity identified in each record is associated with the target entity. For example, the risk assessment application 106 can determine whether identifying information in the retrieved state record matches the identifying information contained in the risk report request. In some examples, the risk assessment application 106 can compare information included in the state data with other records associated with the target entity to confirm the identity of the target entity.

At interactions 322 and 324, the process 300 can include performing, by the data retrieval module 122, audit and billing operations, respectively. In some aspects, the audit and billing operations can be performed by the fulfilment service 108. In other aspects, audit and billing operations can be performed by the audit service 114 and the order management service 116, respectively. An audit operation can include generating an audit log including the risk report request, the retrieved data, the report requestor, and the date or time of the request. A billing operation can include generating a billing session and, within that billing session, generating a billing item based on the number of records and amount of information requested.

At interaction 326, the process 300 can include transmitting, by the data retrieval module 122, the risk report to the product gateway service 110, which, in turn, transmits the risk report to the fulfilment service 108 at interaction 328. Based on the risk report generated by the data retrieval service 122, the fulfilment service 108 can generate and transmit an order record to the order management service 116 at interaction 330. The order record can be used, for example, to track billing or for internal auditing. The order management service 116 can, in response, generate an order identifier and, at interaction 332, transmit the order identifier to the fulfilment service 108. In some examples, the order identifier can be used for internal tracking by the risk assessment application 106.

At interaction 334, the process 300 can include appending, by the fulfilment service 108, the order identifier for the risk report and transmitting, to the client computing system 126, the risk report at interaction 336 via the front-end module 124. The risk report can be transmitted, for example, in a format selected by the user via the GUI generated by the front-end module 124. The client computing system 126 can then use the risk report to determine whether or not to grant access to the interactive computing environment 134 to the target entity. For example, the risk report can include a risk indicator associated with the target entity. The risk indicator can be calculated by one or more components of the risk assessment application 106 and can indicate a risk associated with allowing the target entity to access the secure computing environment 134.

In some examples, the user can continue to interact with the GUI generated by the front-end module 124 to dynamically retrieve any combination of state records and data fields within those records. For example, after receiving the risk report, the user can choose to refine the report by selecting a different subset of states or of data fields. Once the revised request is received by the fulfilment service 108, the fulfilment service 108 can initiate a second trigger event, causing the order management service 116 to add an additional billing item to the billing session. The second trigger event can also cause the audit service 114 to generate a second audit log associated with the session and indicating the revised risk report request.

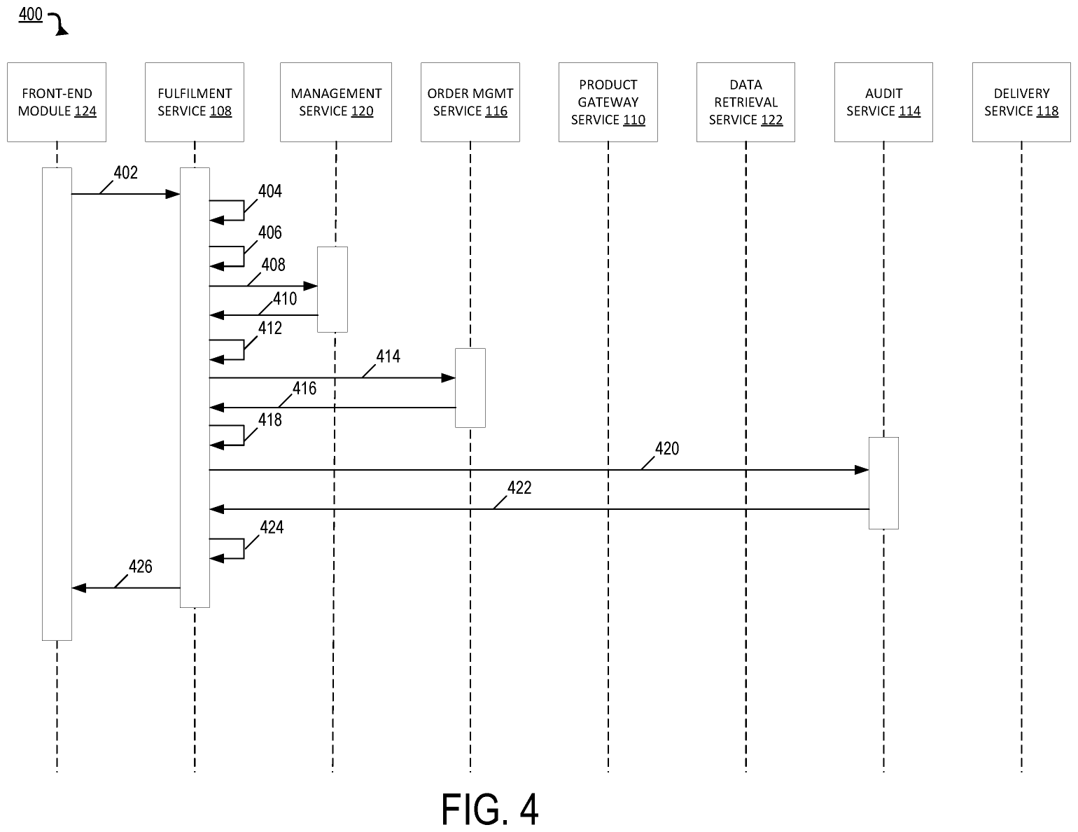

FIG. 4 is a block diagram depicting an example process 400 for retrieving a previously generated risk report associated with a target entity according to some aspects of the present disclosure. The process 400 can be implemented by any of the components as described above with reference to FIG. 1 or FIG. 2. For example, the interactions described with respect to FIG. 4 can be executed by the risk assessment server 102 via one or both of public network 136 and network 138. Other implementations or architectures, however, are possible.

In some aspects, interactions 402 through 412 can correspond to interactions 302 through 312 described with reference to FIG. 3. For example, the risk assessment application 106 can receive a request for a previously executed risk report for a target entity. The request can be received via the front-end module 124 from the client computing system 126. [0045] The fulfilment service 108 can validate the received request, for example, to determine whether the request includes a valid target entity identifier (e.g., a valid serial number or valid SSN) and a valid user identifier, and can also validate a token provided by the client computing device 126 as part of the request.

In some aspects, once the user is authenticated and the associated configuration record is retrieved, the fulfilment service 108 can, at interaction 414, transmit the target entity identifier to the order management service 116. The order management service 116 can use the target entity identifier to retrieve the previously generated risk reports associated with the target entity, e.g., from an order management database of the risk assessment system 102. At interaction 416, the process 400 can include transmitting a list of entities who previously requested risk reports on the target entity to the fulfilment service 108. For example, the list can include entities or users who requested risk reports associated with the target entity and the order identifiers associated with each report.

In some examples, the process 400 can include an interaction 418 for identifying the risk report associated with the user and identifying the order number associated with the risk report. Once the appropriate order identifier is determined, at interaction 420, the process 400 can include transmitting, by the fulfilment service 108, the order identifier to the audit service 114. The audit service 114 can query records stored in an audit database of the risk assessment system 102 to identify the risk report associated with the order identifier. At interaction 422, the audit service 114 can transmit the retrieved risk report to the fulfilment service 108.

In some aspects, the process 400 can include an interaction 424 for appending the order identifier and other order information retrieved by the order management service 116 to the retrieved risk report. The combined risk report and order information can be transmitted, at interaction 426, to the client device 126 via the front-end module 124. Thus, by using the audit information generated while producing the original risk report, the user can dynamically retrieve past risk reports.

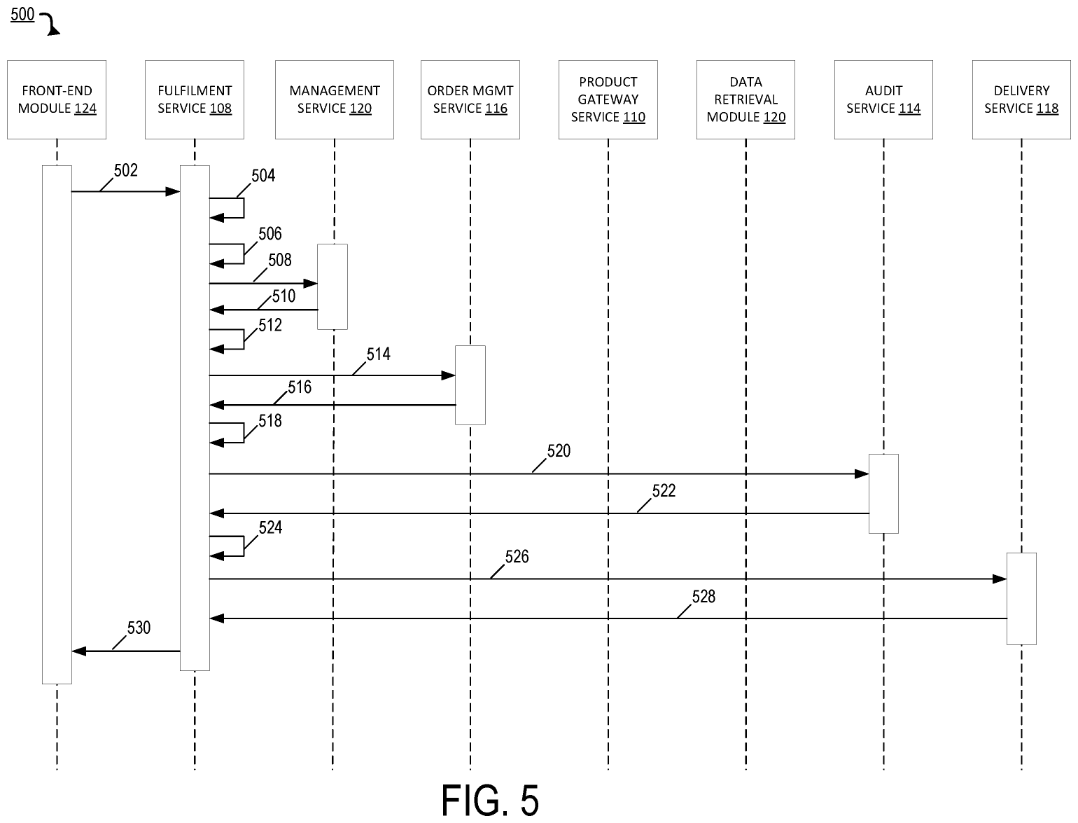

FIG. 5 is a block diagram depicting an example process 500 for retrieving a previously generated risk report in a specified delivery format according to some aspects of the present disclosure. The process 500 can be implemented by any of the components as described above with reference to FIG. 1 or FIG. 2. For example, the interactions described with respect to FIG. 5 can be executed by the risk assessment server 102 via one or both of public network 136 and network 138. Other implementations or architectures, however, are possible.

In some aspects, interactions 502 through 524 can correspond to interactions 402 through 424 described with reference to FIG. 4. For example, the risk assessment application 106 can retrieve a previously generated risk report associated with a target entity using the order management service 116 and the audit service 114. The request for the previously generated risk report received from the client computing system 126 can include a selection of a delivery method (e.g., a particular file type or format).

At interaction 526, the process 500 can include transmitting the retrieved risk report information and the selection of the delivery method to the delivery service 118. The delivery service 118 can format the retrieved risk report in the desired format. For example, the delivery service 118 can transform raw data into a formatted report in the desired file type. The delivery service 118 can, at interaction 528, transmit the formatted risk report to the fulfilment service 108. At interaction 530, the process 500 can include providing, by the fulfilment service 108, the formatted risk report to the client computing system 126 via the interface generated by the front-end module 124.

Techniques for Generating a Risk Indicator Associated with a Target Entity

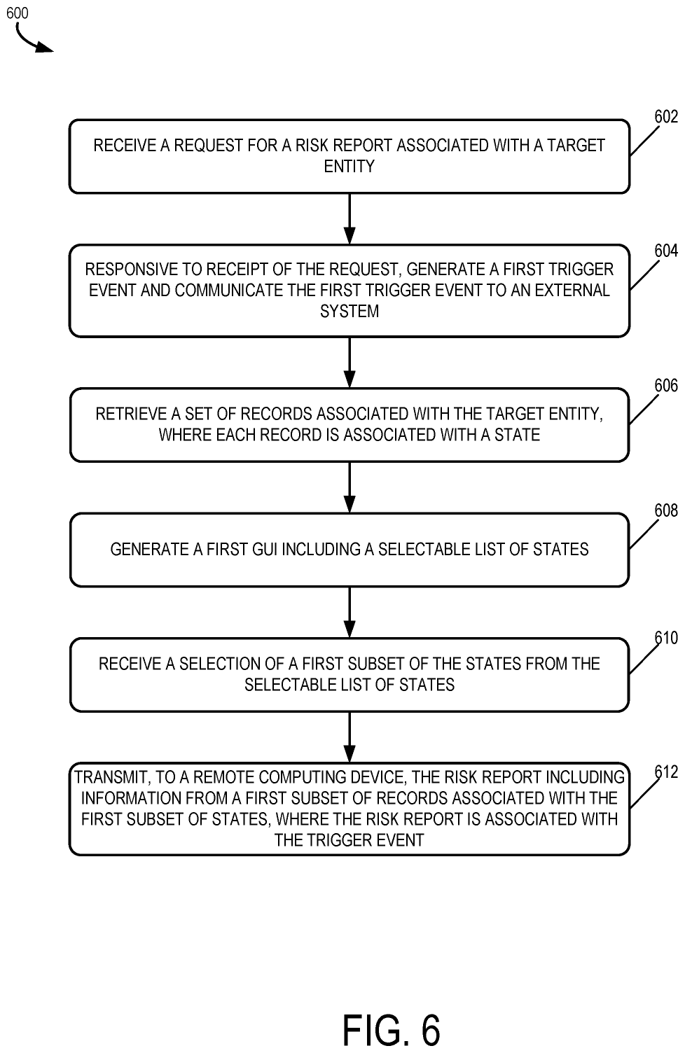

FIG. 6 is a flow chart illustrating an example of a method 600 for generating a risk assessment associated with a target entity according to some aspects of the present disclosure. In some examples, the steps of the method 600, or any subset thereof, may be performed by the risk assessment computing system 102 via the risk assessment server 104, but other suitable systems, devices, or subsets or combinations thereof may perform one or more operations described with respect to the method 600. For illustrative purposes, the method 600 is described with reference to certain examples depicted in the figures. Other implementations, however, are possible.

At block 602, the risk assessment computing system 102 can receive a request from a remote computing device (e.g., the client computing device 126) for a risk report associated with a target entity. The request can include, for example, an identifier associated with the target entity and a desired delivery method for the risk report. In some aspects, the request can be received via an API (e.g., the API gateway 112). As previously described, the front-end module 124 can be configured to generate a GUI on the client computing device 126 through which a user can interact with the risk assessment computing system 102 using the API gateway 112.

At block 604, the risk assessment computing system 102 can, in response receiving the request for the risk report, generate a first trigger event associated with the request and communicate the first trigger event to an external system. For example, the trigger event can be associated with the generation of the requested risk report. In some aspects, the trigger event can be communicated to a system (e.g., a billing or audit system) external to the risk assessment computing system 102. In other aspects, the trigger event can be communicated to the order management service 116 of the risk assessment application 106. The order management service 116 can initiate a billing session associated with the risk report request and record, in response to the trigger event, a billing item based on the requested risk report.

In some examples, the order management service 116 can generate multiple billing items in real time as the user interacts with the risk management computing system 102 to generate multiple risk reports. Once the use ends the session, the order management service 116 can close the billing session and transmit the list of billing items to an external system for invoicing and collection. Thus, the risk assessment computing system 102 can reduce the number of transactions required to generate multiple risk reports. Further, the risk management system 102 can generate invoices at a granular level based on exactly how many records and how much information the user requests.

At block 606, the risk assessment computing system 102 can retrieve, from a database (e.g., data repository 128), a set of records associated with the target entity based on the identifier. Each record of the set of records can be associated with a state. For example, the data retrieval module 122 of the risk assessment application 106 can generate a query based on the target entity identifier. Executing the query on the data repository 128 can return a set of records associated with the target identifier.

At block 608, the risk assessment computing system 102 can generate a first GUI that is displayed to a user via the remote computing device. For example, the front-end module 124 can be configured to generate the first GUI where the first GUI displays a selectable list of states including the states associated with each record. The selectable list enables the user to select states of the target entity to include in the risk report or upon which to base a risk indicator.

At block 610, the risk assessment computing system 102 can receive, via the API (e.g., the API gateway 112), a selection of a first subset of the states of the selectable list of states. For example, the user can, via the first GUI, select a subset of the states. In some aspects, the user can also select from a selectable list of data fields. The data fields can correspond to particular data available in each record. In some examples, the risk assessment application 106 can retrieve a configuration associated with the user from a management service (e.g., management service 120). The displayed selectable list of data fields can be based on a set of permissions included in the configuration. For example, based on the permissions in the configuration, the user may not have access to every available data field. Thus, only those to which the user has access will be displayed.

At block 612, the risk assessment computing system 102 can transmit, to a remote computing device (e.g., the client computing system 126), the generated risk report. The risk report can include at least information from a first subset of records associated with the first subset of states. In some aspects, the risk assessment computing system 102 can associate the risk report with the first trigger event, e.g., using an order identifier. The order identifier can be used to track the risk report and to retrieve past risk reports.

In some examples, the user can receive the generated risk report via a second GUI that displays the risk report, as well as the selectable lists of states and data fields. The user can then modify the risk report by selecting a second subset of states from the selectable list. In response, the risk assessment computing system 102 can initiate a second trigger event configured to cause the order management service 116 to generate a second billing item and the audit service 114 to generate a second audit log. The risk assessment computing system 102 can compile the modified risk report based on the selected second subset of states and transmit the risk report to the client computing device 126. In some examples, the risk report can include a modified risk indicator associated with the target entity based on the modified subset of data. Thus, the user can dynamically explore how different states affect the risk indicator of the target entity.

Systems and methods described herein provide advantages over traditional background screening systems. For example, described systems and methods can provide results more efficiently by enabling the user to dynamically generate custom risk reports in real time. This reduces overhead and reduces transmissions required between components to generate and track the risk report. The risk assessment computing system 102 can further enable the user to generate risk reports and risk indicators that capture varying levels of specificity. For example, the user can customize the amount of data and types of information captured in the risk indicator, thereby enabling more accurate decisions on whether to grant the target entity access to restricted systems or resources.

### Example of Computing System

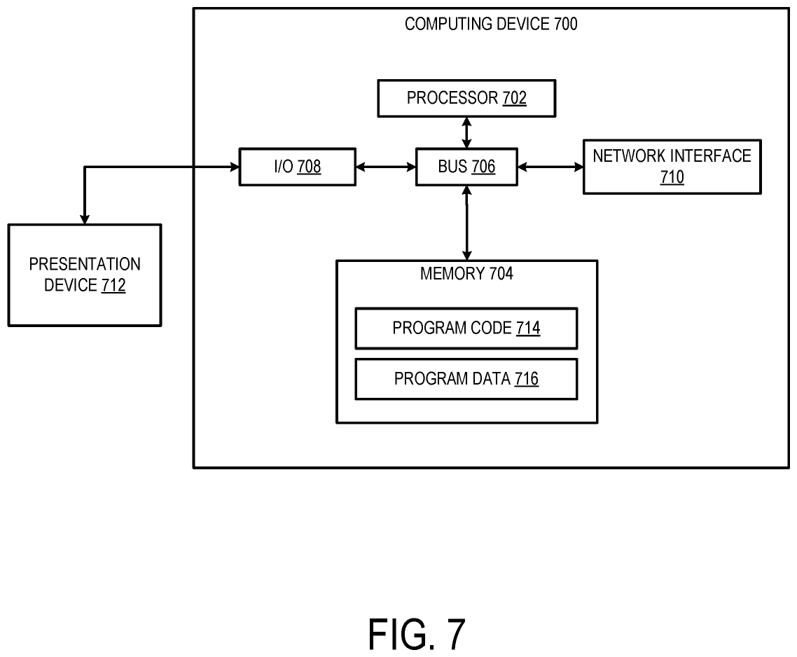

Any suitable computing system or group of computing systems can be used to perform the operations for the techniques described herein. For example, FIG. 7 is a block diagram depicting an example of a computing device 700, which can be used to implement the risk assessment server 104. The computing device 700 can include various devices for communicating with other devices in the computing environment 100, as described with respect to FIG. 1. The computing device 700 can include various devices for performing one or more operations, such as risk assessment operations, described above with respect to FIGS. 1-6.

The computing device 700 can include a processor 702 that can be communicatively coupled to a memory 704. The processor 702 can execute computer-executable program code stored in the memory 704, can access information stored in the memory 704, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 702 can include a microprocessor, an application-specific integrated circuit (ASIC), a field-programmable gate array (FPGA), or any other suitable processing device. The processor 702 can include any suitable number of processing devices, including one. The processor 702 can include or communicate with a memory 704. The memory 704 can store program code that, when executed by the processor 702, causes the processor 702 to perform the operations described herein.

The memory 704 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C#, Visual Basic, Java, Python, Perl, JavaScript, ActionScript, etc.

The computing device 700 may also include a number of external or internal devices such as input or output devices. For example, the computing device 700 is illustrated with an input/output interface 708 that can receive input from input devices or provide output to output devices. A bus 706 can also be included in the computing device 700. The bus 706 can communicatively couple one or more components of the computing device 700.

The computing device 700 can execute program code 714 that can include risk assessment application 106. The program code 714 for the risk assessment application 106 may be resident in any suitable computer-readable medium and may be executed on any suitable processing device. For example, and as illustrated in FIG. 7, the program code 714 for the risk assessment application 106 can reside in the memory 704 at the computing device 700 along with the program data 716 associated with the program code 714. Executing the risk assessment application 106 can configure the processor 702 to perform at least a portion of the operations described herein.

In some aspects, the computing device 700 can include one or more output devices. One example of an output device can be or include the network interface device 710 illustrated in FIG. 7. A network interface device 710 can include any device or group of devices suitable for establishing a wired or wireless data connection to one or more data networks described herein. Non-limiting examples of the network interface device 710 can include an Ethernet network adapter, a modem, etc.

Another example of an output device can include the presentation device 712 depicted in FIG. 7. A presentation device 712 can include any device or group of devices suitable for providing visual, auditory, or other suitable sensory output. Non-limiting examples of the presentation device 712 can include a touchscreen, a monitor, a speaker, a separate mobile computing device, etc. In some aspects, the presentation device 712 can include a remote client-computing device that communicates with the computing device 700 using one or more data networks described herein. In other aspects, the presentation device 712 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A computer-implemented method comprising:
receiving, by a processor via an application programming interface (API) from a remote computing device, a request for a risk report associated with a target entity, wherein the target entity is associated with an identifier;
responsive to receipt of the request, generating, by the processor, a first trigger event associated with the request and communicating the first trigger event to an external system;
retrieving, by the processor from a database, a set of records associated with the target entity based on the identifier, wherein each record of the set of records is associated with a state;
generating, by the processor, a first graphical user interface (GUI) that is displayed to a user via the remote computing device, wherein the first GUI comprises a selectable list of states associated with each record of the set of records;
receiving, by the processor via the API, a selection of a first subset of the states selected by the user via the first GUI;
transmitting, by the processor to the remote computing device, the risk report comprising at least information from a first subset of records associated with the first subset of states, wherein the risk report is associated with the trigger event and is useable for controlling access of the target entity to one or more interactive computing environments.

2. The method of claim 1, wherein the first GUI further comprises a selectable list of data fields from each record to include in the risk report.

3. The method of claim 2, further comprising:
retrieving, by the processor from a management service, a configuration associated with the user, the configuration comprising a set of permissions; and
generating, by the processor, the selectable list of data fields based at least in part on the set of permissions.

4. The method of claim 1, wherein the first GUI further comprises a selectable list of delivery options and wherein the method further comprises:
receiving, by the processor via the first GUI, a selection of a delivery type;
transmitting, by the processor, the information from the subset of records and the delivery type to a delivery service;
receiving, by the processor from the delivery service, the risk report comprising the information from the subset of records, wherein the risk report is in a format associated with the delivery type; and
transmitting, by the processor to the remote computing device, the formatted risk report.

5. The method of claim 1, further comprising:
generating, by the processor, a second GUI comprising the information from the subset of records and the selectable list of states;
receiving, by the processor, a selection of a second subset of states from the selectable list of states via the second GUI;
responsive to the selection of the second subset of states, generating, by the processor, a second trigger event based on the selection of the second subset of states and communicating the second trigger event to the external system, wherein the first trigger event and the second trigger event are associated with a session and wherein the session is associated with the request for the risk report; and
transmitting, by the processor to the remote computing device, an updated risk report comprising at least information from the first subset of records associated with the first subset of states and a second subset of records associated with the second subset of states and wherein the risk report is associated with the first trigger event and the second trigger event.

6. The method of claim 1, further comprising:
generating, by the processor, audit data associated with the request for the risk report, wherein the audit data comprises the selection of the first subset of states and wherein the audit data is associated with the first trigger event; and
storing, by the processor, the audit data in an audit database.

7. The method of claim 6, further comprising;
receiving, by the processor from the remote computing device, a request for audit data associated with the target entity;
retrieving, by the processor from the audit database, a set of audit data associated with the target entity; and
transmitting, by the processing device to the remote computing device, the set of audit data.

8. A system comprising:
a processor; and
a non-transitory computer-readable medium comprising instructions that are executable by the processor for causing the processor to perform operations comprising:
receiving, via an application programming interface (API) from a remote computing device, a request for a risk report associated with a target entity, wherein the target entity is associated with an identifier;
responsive to receipt of the request, generating a first trigger event associated with the request and communicating the first trigger event to an external system;
retrieving, from a database, a set of records associated with the target entity based on the identifier, wherein each record of the set of records is associated with a state;
generating a first graphical user interface (GUI) that is displayed to a user via the remote computing device, wherein the first GUI comprises a selectable list of states associated with each record of the set of records;
receiving, via the API, a selection of a first subset of the states selected by the user via the first GUI;
transmitting, to the remote computing device, the risk report comprising at least information from a first subset of records associated with the first subset of states and wherein the risk report is associated with the trigger event.

9. The system of claim 8, wherein the first GUI further comprises a selectable list of data fields from each record to include in the risk report.

10. The system of claim 9, wherein the operations further comprise:
retrieving, from a management service, a configuration associated with the user, the configuration comprising a set of permissions; and
generating the selectable list of data fields based at least in part on the set of permissions.

11. The system of claim 8, wherein the first GUI further comprises a selectable list of delivery options and wherein the operations further comprise:
receiving, via the first GUI, a selection of a delivery type;
transmitting the information from the subset of records and the delivery type to a delivery service;
receiving, from the delivery service, the risk report comprising the information from the subset of records, wherein the risk report is in a format associated with the delivery type; and
transmitting, to the remote computing device, the formatted risk report.

12. The system of claim 8, wherein the operations further comprise:
generating a second GUI comprising the information from the subset of records and the selectable list of states;
receiving a selection of a second subset of states from the selectable list of states via the second GUI;
responsive to the selection of the second subset of states, generating a second trigger event based on the selection of the second subset of states and communicating the second trigger event to the external system, wherein the first trigger event and the second trigger event are associated with a session and wherein the session is associated with the request for the risk report; and
transmitting, to the remote computing device, an updated risk report comprising at least information from the first subset of records associated with the first subset of states and a second subset of records associated with the second subset of states and wherein the risk report is associated with the first trigger event and the second trigger event.

13. The system of claim 8, wherein the operations further comprise:
generating audit data associated with the request for the risk report, wherein the audit data comprises the selection of the first subset of states and wherein the audit data is associated with the first trigger event; and
storing the audit data in an audit database.

14. The system of claim 13, wherein the operations further comprise:
receiving, from the remote computing device, a request for audit data associated with the target entity;
retrieving, from the audit database, a set of audit data associated with the target entity; and
transmitting, to the remote computing device, the set of audit data.

15. A non-transitory computer-readable storage medium having program code that is executable by a processor device to cause a computing device to perform operations, the operations comprising:
receiving, via an application programming interface (API) from a remote computing device, a request for a risk report associated with a target entity, wherein the target entity is associated with an identifier;
responsive to receipt of the request, generating a first trigger event associated with the request and communicating the first trigger event to an external system;
retrieving, from a database, a set of records associated with the target entity based on the identifier, wherein each record of the set of records is associated with a state;
generating a first graphical user interface (GUI) that is displayed to a user via the remote computing device, wherein the first GUI comprises a selectable list of states associated with each record of the set of records;
receiving, via the API, a selection of a first subset of the states selected by the user via the first GUI;
transmitting, to the remote computing device, the risk report comprising at least information from a first subset of records associated with the first subset of states and wherein the risk report is associated with the trigger event.

16. The non-transitory computer-readable storage medium of claim 15, wherein the first GUI further comprises a selectable list of data fields from each record to include in the risk report.

17. The non-transitory computer-readable storage medium of claim 16, wherein the operations further comprise:
retrieving, from a management service, a configuration associated with the user, the configuration comprising a set of permissions; and
generating the selectable list of data fields based at least in part on the set of permissions.

18. The non-transitory computer-readable storage medium of claim 15, wherein the first GUI further comprises a selectable list of delivery options and wherein the operations further comprise:
receiving, via the first GUI, a selection of a delivery type;
transmitting the information from the subset of records and the delivery type to a delivery service;
receiving, from the delivery service, the risk report comprising the information from the subset of records, wherein the risk report is in a format associated with the delivery type; and
transmitting, to the remote computing device, the formatted risk report.

19. The non-transitory computer-readable storage medium of claim 15, wherein the operations further comprise:
generating a second GUI comprising the information from the subset of records and the selectable list of states;
receiving a selection of a second subset of states from the selectable list of states via the second GUI;
responsive to the selection of the second subset of states, generating a second trigger event based on the selection of the second subset of states and communicating the second trigger event to the external system, wherein the first trigger event and the second trigger event are associated with a session and wherein the session is associated with the request for the risk report; and
transmitting, to the remote computing device, an updated risk report comprising at least information from the first subset of records associated with the first subset of states and a second subset of records associated with the second subset of states and wherein the risk report is associated with the first trigger event and the second trigger event.

20. The method of claim 15, wherein the operations further comprise:
generating audit data associated with the request for the risk report, wherein the audit data comprises the selection of the first subset of states and wherein the audit data is associated with the first trigger event; and
storing the audit data in an audit database.
